(19) United States
(12) Patent Application Publication
(10) Pub. No.: US 2023/0394580 A1
(43) Pub. Date: Dec. 7, 2023

(54) MUSIC INVESTMENT SYSTEM

(71) Applicant: MUSIC SECURITIES, INC, CHIYODA-KU, TOKYO (JP)

(72) Inventor: Masami KOMATSU, CHIYODA-KU, TOKYO (JP)

(21) Appl. No.: 18/022,044

(22) PCT Filed: Aug. 21, 2020
(86) PCT No.: PCT/JP2020/031719

§ 371 Date: Feb. 17, 2023

(51) Int. Cl. G06Q 40/06

(52) U.S. Cl. CPC G06Q 40/06

(57) ABSTRACT

Provided is a music investment system, with which transparency of the flow of invested funds is maintained and with which an investor is able to invest with confidence. The music investment system includes a server, an artist device, and an investor device. The server includes: an investment object information reception unit that receives ownership information indicating the ownership of an artist and the ownership of an investor of an investment object; an investor registry update unit; a musical content reception unit that prepares ownership transfer information for music content; a music content delivery unit; a profit information reception unit; and a profit distribution unit that issues tokens in accordance with the quantity of profit distributed to each investor. The investor device has a display control unit that displays information recorded in the recording unit.

### TECHNICAL FIELD

The present invention relates to a music investment system.

### BACKGROUND ART

Conventionally, there has been known an investment system (for example, refer to Patent Literature 1).

According to an investment system in Patent Literature 1, a user is able to invest in music production or the like of an artist by using a network.

### CITATION LIST

### Patent Literature

Patent Literature 1: Japanese Unexamined Patent Application Publication No. 2008-171447

### SUMMARY OF INVENTION

### Technical Problem

An investor who intends to invest in the production of music through an investment system determines whether to invest through an investment system, taking into consideration not only the attractiveness of an artist himself/herself but also whether the investment system is a reliable system.

In addition, whether the transparency of the flow of invested funds is maintained is an important factor for the investor to determine whether the system is reliable.

In the system in Patent Literature 1, however, no consideration is given to showing the investor the transparency of the flow of invested funds, and the flow of funds is opaque to the investor.

Therefore, the investor feels uneasy to invest because the investor cannot determine whether the system is reliable, and the investor hesitates to invest even if the investor is attracted to the artist. As a result, an artist who wants to call for investment for the production of music or the like may not be able to raise funds as expected.

In view of the above circumstances, an object of the present invention is to provide a music investment system capable of ensuring transparency of the flow of invested funds and enabling investors to invest with confidence.

### Solution to Problem

According to the present invention, there is provided a music investment system according to the present invention, having a computer network including a server, an artist device, and an investor device, wherein the server includes: an investment object information reception unit that receives investment object information from the artist device and that records the investment object information in a recording unit, the investment object information being information about a music to be an object of investment by an investor and information including ownership information indicating ownership of an artist and ownership of the investor of the investment object; an investor registry update unit that receives investment volume information including information identifying the investment object, information identifying the investor, and information indicating the volume of investment from the investor device, prepares investor registry information based on the received investment volume information, and records the investor registry information into the recording unit; a music content reception unit that receives a music content, which is information including audio information of a music produced or purchased with funds invested by the investor from the artist device, records the music content into the recording unit, prepares ownership transfer information indicating that the ownership of the music content has been transferred to the each investor, on the basis of the ownership information included in the investment object information corresponding to the music content and the volume of investment of the each investor included in the investor registry information to which the music content corresponds, and records the ownership transfer information into the recording unit; a music content delivery unit that delivers the music content received by the music content reception unit to the investor device; a profit information reception unit that receives profit information including information identifying a source of profit payment of the music content delivered by the music content delivery unit and information indicating the amount of profit and records the profit information into the recording unit; and a profit distribution unit that decides the quantity of profit distributed to the each investor for each investment object, based on the ownership transfer information and the profit information, issues tokens to the each investor according to the decided quantity of profit distributed to the each investor, and records the information indicating the quantity of the issued tokens into the recording unit, wherein the investor device includes a display control unit that acquires each of the investor registry information recorded in the recording unit, the ownership transfer information, the profit information, and the information indicating the quantity of the tokens issued to the investor in response to an operation of the investor and displays the information identifying the investor, the information indicating the volume of investment, the information indicating the quantity of transferred ownership, or the information indicating the quantity of the issued tokens, each of which is related to each investor including the investor himself/herself who performed the operation, on the basis of the acquired information, on the investor device.

In the present invention, the investment object information reception unit receives the investment object information, which is information about a music to be an object of investment by an investor and information including the ownership information indicating the ownership of an artist and the ownership of the investor of the investment object, from the artist device and records the investment object information into the recording unit. Note that the ownership is a value indicating the quantity of the right to receive the distributed profit of the investment object.

Moreover, the investor registry update unit prepares investor registry information including information identifying the investment object, information identifying the investor, and information indicating the volume of investment and records the investor registry information into the recording unit.

Further, the music content reception unit prepares the ownership transfer information indicating that the ownership of a music content, which is information including the audio information of a music produced or purchased with funds invested by the investor from the artist device, the music content being received from the artist terminal, has been transferred to each investor, on the basis of the ownership information and the volume of investment of each investor, and then records the ownership transfer information into the recording unit.

Moreover, the profit information reception unit receives profit information including information identifying the source of profit payment of the music content delivered by the music content delivery unit and information indicating the amount of profit, and records the profit information into the recording unit

In addition, the profit distribution unit decides the quantity of profit distributed to each investor for each investment object on the basis of the ownership transfer information and the profit information, issues tokens according to the decided quantity of profit distributed to each investor, and records the information indicating the quantity of the issued tokens into the recording unit.

Then, a display control unit acquires each of the investor registry information, the ownership transfer information, the profit information, and the information indicating the quantity of the tokens issued to the investor recorded in the recording unit in response to an operation of the investor, and then displays on the investor device based on the acquired information, such as the information identifying the investor, the information indicating the volume of investment, the information indicating the quantity of transferred ownership, or the information indicating the quantity of the issued tokens, each of which is related to each investor including the investor himself/herself who performed the operation.

This allows each investor to confirm at any time that the ownership is transferred to each investor in proportion to his/her investment and that each investor is receiving a distributed profit according to his/her ownership, and therefore the investor is able to invest with confidence, thus increasing the possibility that the artist is able to raise a lot of funds.

As described above, according to the music investment system of the present invention, transparency of the flow of invested funds is maintained, thus enabling the investor to invest with confidence.

In the music investment system of the present invention, preferably, the music content reception unit is configured to receive also delivery object information, which is information indicating the investor who is to receive delivery of the music content, when receiving the music content from the artist device, and the music content delivery unit is configured to deliver the music content to an investor device used by the investor who is to receive delivery, on the basis of the delivery object information for each music content, when delivering the music content to the investor device.

In the present invention, when the music content reception unit receives the music content information, information indicating the investor to whom the music content is delivered is also received, for example, on the basis of the artist's own operation.

When the music content delivery unit delivers the music content, the music content is delivered to the investor device used by the investor to whom the music content is delivered, on the basis of the delivery object information for each music content.

This allows an artist to deliver a music content as a limited content that is to be delivered to specific investors. The investors who received the limited content will feel more familiar with the artist and will be more willing to invest in the artist, thus increasing the likelihood that the artist will be able to raise a lot of funds.

Thus, according to the music investment system of the present invention, transparency of the flow of invested funds is maintained, and investors are able to invest with confidence while feeling closer to the artist.

In the music investment system of the present invention, preferably, the music content reception unit is configured to receive also redelivery availability information, which is information indicating whether the investor is allowed to redeliver the music content to other devices, when receiving the music content from the artist device, and the investor device has a redelivery unit that redelivers the music content to other devices in response to an operation of the investor in the case where the content of the redelivery availability information for each music content indicates that the music content is allowed to be redelivered to other devices.

In the present invention, when receiving the music content information, the music content reception unit receives information indicating whether the investor is allowed to redeliver the music content to other devices on the basis of the artist's own operation, for example.

Then, regarding a redeliverable music content, the redelivery unit redelivers the music content to other devices other than the investor device on the basis of the investor's operation.

This allows the investors themselves to participate in the promotional activities of the artist, which raises their expectations of earning a large amount of profit depending on their own efforts, thus increasing the investors' willingness to invest, which in turn increases the possibility that the artist is able to raise a lot of funds.

As described above, according to the music investment system of the present invention, transparency of the flow of invested funds is maintained, and the investors themselves are able to participate in the promotional activities of the artist and to invest with confidence while feeling closer to the artist.

In the music investment system of the present invention, preferably, the music investment system includes a profit manager device, the server includes a fund use information reception unit that receives fund use information, which is information about the use of the funds invested by the investor, from the profit manager device and that records the fund use information into the recording unit, and the display control unit of the investor device acquires the fund use information recorded in the recording unit and displays the fund use information on the investor device.

In the present invention, the fund use information reception unit records the fund use information, which is information about the use of the funds invested by the investor and which is received from the profit manager device, into the recording unit. Then, the display control unit acquires the fund use information, which is recorded in the recording unit, in response to the investor's operation, and then displays the fund use information on the investor device.

This allows the investor to confirm at any time the use of funds invested by himself/herself, and therefore the investor is able to invest with more confidence, thus increasing the possibility that the artist is able to raise a lot of funds.

As described above, according to the music investment system of the present invention, the transparency of the flow of funds including the use of funds invested by investors is maintained, thereby allowing the investors to invest with more confidence.

In the music investment system of the present invention, preferably, there is a plurality of servers as the server, and each server has a blockchain unit that generates block data on the basis of a certain number of pieces of prescribed information each time the certain number of pieces of prescribed information are recorded into the recording unit, adds the block data to the blockchain, and manages the blockchain with other servers in a distributed manner.

In the present invention, there is the plurality of servers, and the blockchain unit manages the prescribed information as the blockchain with other servers in a distributed manner.

This increases the certainty that important information, such as the investor registry information, the profit information, and the information indicating the quantity of profit distributed to each investor, has not been tampered, thereby enabling investors to invest with more confidence, thus increasing the possibility that the artist is able to raise a lot of funds.

As described above, the music investment system according to the present invention ensures transparency of the flow of invested funds, thereby enabling investors to invest with more confidence.

### BRIEF DESCRIPTION OF DRAWINGS

FIG. 1A is a block diagram illustrating an overall configuration of a music investment system.

FIG. 1B is a block diagram illustrating a configuration of the music investment system.

FIG. 1C is a block diagram illustrating a configuration of the music investment system.

FIG. 1D is a block diagram illustrating a configuration of the music investment system.

FIG. 1E is a block diagram illustrating a configuration of the music investment system.

FIG. 1F is a network diagram illustrating an example of an overall configuration of the music investment system.

FIG. 2 is a flowchart outlining the processing of the entire music investment system.

FIG. 3A is a flowchart illustrating a processing flow of the music investment system.

FIG. 3B is a flowchart illustrating a processing flow of the music investment system.

FIG. 4A is a chart illustrating a data structure of the music investment system.

FIG. 4B is a chart illustrating a data structure of the music investment system.

FIG. 4C is a chart illustrating a data structure of the music investment system.

FIG. 5 is a diagram illustrating an output content of the music investment system.

### DESCRIPTION OF EMBODIMENTS

<Configuration of Music Investment System>

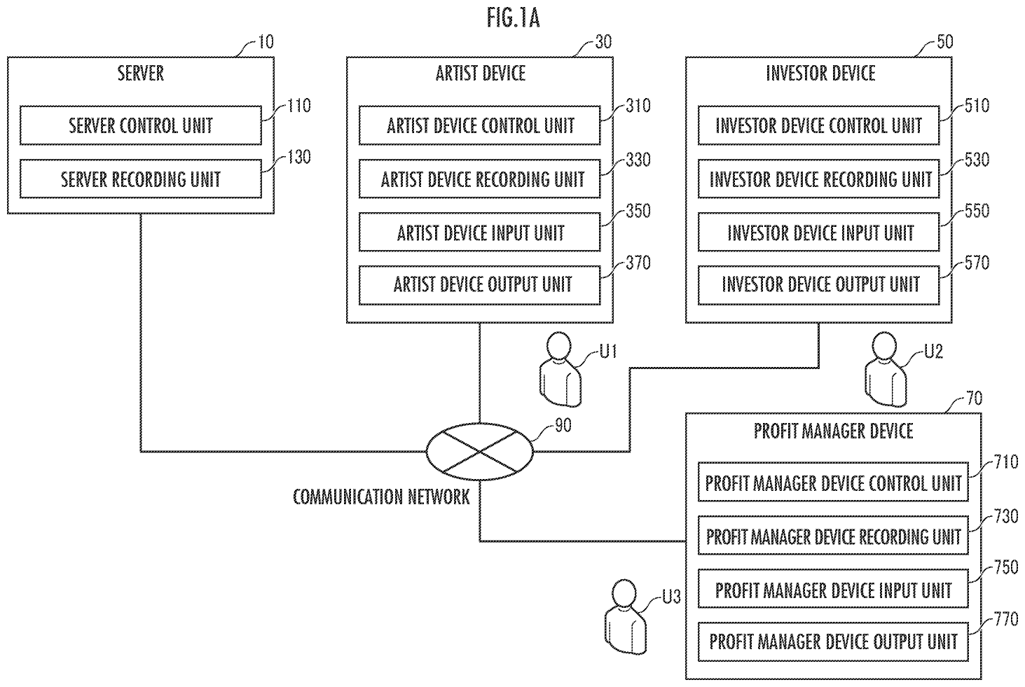

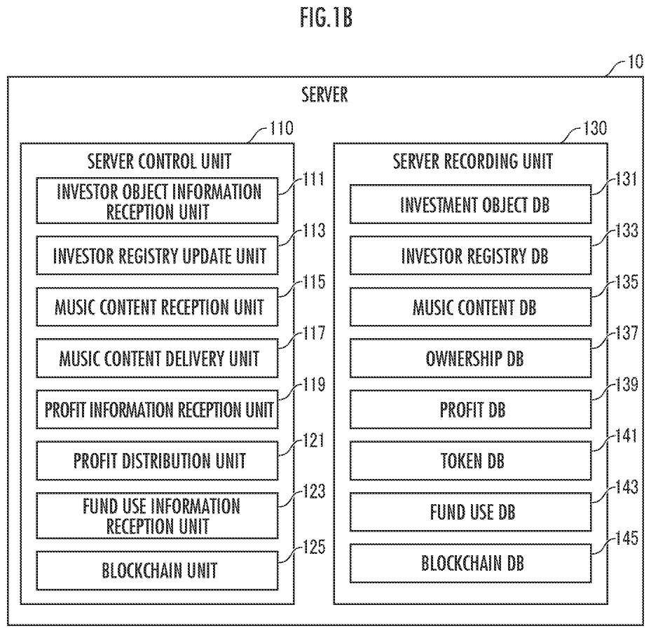

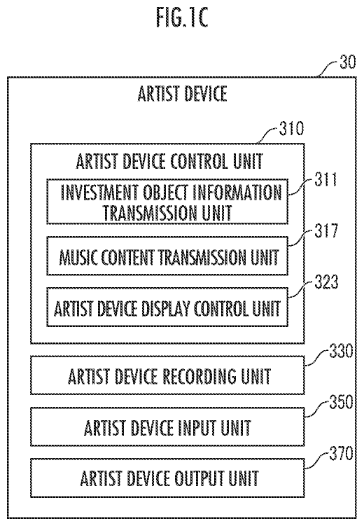

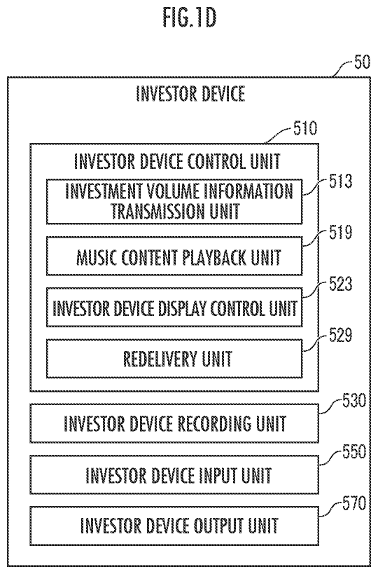

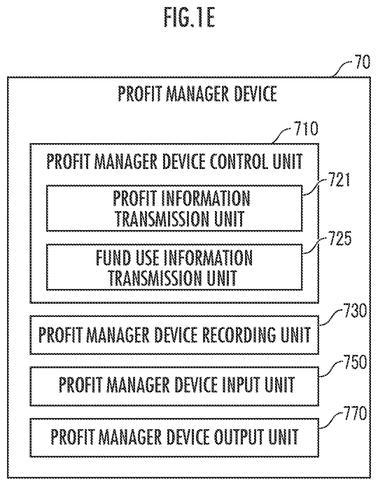

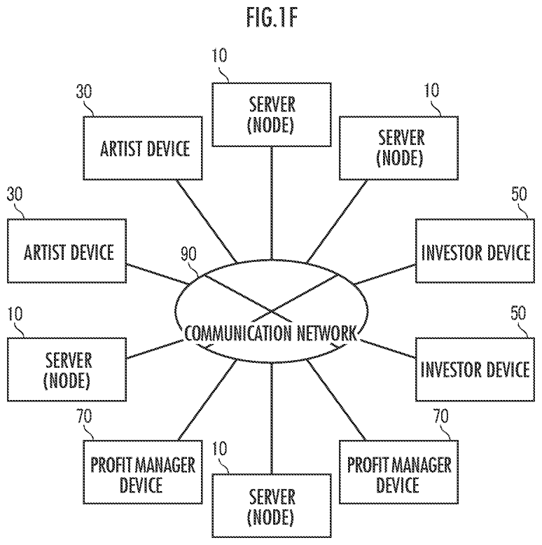

First, the configuration of a music investment system of this embodiment is described with reference to FIGS. 1A to 1F. The music investment system of this embodiment includes a server 10, an artist device 30, and an investor device 50, and alternatively further includes a profit manager device 70.

The server 10, the artist device 30, the investor device 50, and the profit manager device 70 are mutually communicatively connected via a communication network 90 to form a computer network system. In the case of a plurality of servers 10, a blockchain network, in which each server 10 functions as a node, may be configured with the servers 10 in the blockchain network managing the blockchain in a distributed manner.

The server 10 is a computer, for example, including a server control unit 110 and a server recording unit 130.

The server control unit 110 is composed of a central processing unit (CPU) and other arithmetic processing units, a memory, input/output (I/O) devices, and the like. The server control unit 110 reads and executes a prescribed program to function as an investment object information reception unit 111, an investor registry update unit 113, a music content reception unit 115, a music content delivery unit 117, a profit information reception unit 119, or a profit distribution unit 121, and alternatively further to function as a fund use information reception unit 123 or a blockchain unit 125.

The investment object information reception unit 111 receives, from the artist device 30, investment object information, which is information about a music to be an object of investment by an investor U2 and is information including the ownership information indicating the ownership of an artist U1 and the ownership of the investor U2 of the investment object, and then records the investment object information into an investment object database (DB) 131 of the server recording unit 130.

The investor registry update unit 113 receives, from the investor device 50, investment volume information, which includes information identifying the investment object, information identifying the investor U2, and information indicating the volume of investment, prepares investor registry information on the basis of the received investment volume information, and records the investor registry information into an investor registry DB 133 of the server recording unit 130.

The music content reception unit 115 receives, from the artist device 30, a music content, which is information including audio information of a music produced or purchased with funds invested by the investor U2, and then records the music content into a music content DB 135 of the server recording unit 130. Then, the music content reception unit 115 prepares ownership transfer information indicating that the ownership of the music content has been transferred to each of the investors U2 on the basis of the ownership information contained in the investment object information corresponding to the music content and on the basis of the volume of investment of each of the investors U2 contained in the investor registry information corresponding to the music content, and then records the ownership transfer information into an ownership DB 137 of the server recording unit 130.

The music content delivery unit 117 delivers the music content received by the music content reception unit 115 to the investor device 50 and other devices.

The profit information reception unit 119 receives profit information including information identifying the source of profit payment of the music content delivered by the music content delivery unit 117 and information indicating the amount of the profit and then records the profit information into a profit DB 139 of the server recording unit 130.

The profit distribution unit 121 decides the quantity of profit distributed to each investor U2 for each investment object on the basis of the ownership transfer information and the profit information, issues tokens to each investor U2 according to the decided quantity of profit distributed to each investor U2, and records the information indicating the quantity of the issued tokens into a token DB 141 of the server recording unit 130.

The fund use information reception unit 123 receives fund use information, which is information about the use of funds invested by the investor U2, from the profit manager device 70 and records the fund use information into a fund use DB 143 of the server recording unit 130.

In the case of a plurality of servers 10, the blockchain unit 125 generates block data on the basis of a certain number of pieces of prescribed information each time the certain number of pieces of prescribed information are recorded into the server recording unit 130, adds the block data to the blockchain to record the block data into a blockchain DB 145 of the server recording unit 130, and manages the blockchain in a distributed manner with other servers 10.

The server recording unit 130 is composed of storage devices such as, for example, a read only memory (ROM), a random access memory (RAM), and a hard disk drive (HDD). The server recording unit 130 records processing results of the investment object DB 131, the investor registry DB 133, the music content DB 135, the ownership DB 137, the profit DB 139, the token DB 141, the fund use DB 143, the blockchain DB 145, and the server control unit 110.

The investment object DB 131 stores investment object information, the investor registry DB 133 stores an investor registry, the music content DB 135 stores music contents, the ownership DB 137 stores ownership transfer information, the profit DB 139 stores profit information, the token DB 141 stores information indicating the quantity of tokens issued to the investor U2, the fund use DB 143 stores fund use information, and the blockchain DB 145 stores block data generated by the blockchain unit 125 on the basis of a certain number of pieces of prescribed information each time the certain number of pieces of prescribed information are recorded.

The artist device 30 is, for example, a computer, a tablet terminal, or a smartphone that includes an artist device control unit 310, an artist device recording unit 330, an artist device input unit 350, and an artist device output unit 370.

The artist device control unit 310 is composed of an arithmetic processing unit such as a CPU, a memory, I/O devices, and the like. The artist device control unit 310 reads and executes a prescribed program to function as an investment object information transmission unit 311, a music content transmission unit 317, and an artist device display control unit 323.

The investment object information transmission unit 311 transmits investment object information to the server 10 in response to the operation of the artist U1. The music content transmission unit 317 transmits a music content to the server in response to the operation of the artist U1. The artist device display control unit 323 displays the information received from the server 10 on the artist device output unit 370 in response to the operation of the artist U1.

The artist device recording unit 330 is composed of storage devices such as, for example, a ROM, a RAM, an HDD, and the like, and records the results of processing by the artist device control unit 310.

The artist device input unit 350 is, for example, a keyboard, a mouse, a touch panel, or a microphone. The artist device output unit 370 is, for example, a display, a loudspeaker, or a printer.

The investor device 50 is, for example, a computer, a tablet terminal, or a smartphone that includes an investor device control unit 510, an investor device recording unit 530, an investor device input unit 550, and an investor device output unit 570.

The investor device control unit 510 is composed of an arithmetic processing unit such as a CPU, a memory, I/O devices, and the like. The investor device control unit 510 reads and executes a prescribed program to function as an investment volume information transmission unit 513 and as an investor device display control unit 523, and alternatively further as a redelivery unit 529.

The investment volume information transmission unit 513 transmits the investment volume information to the server 10 in response to the operation of the investor U2.

The investor device display control unit 523 acquires each of the investor registry information, the ownership transfer information, the profit information, and the information indicating the quantity of tokens issued to the investor, each of which is recorded in the server recording unit 130, in response to the operation of the investor U2. Then, the investor device display control unit 523 displays information identifying the investor U2 and information indicating the volume of investment, information indicating the quantity of transferred ownership, or information indicating the quantity of the issued tokens, each of which is related to each investor U2 including the investor U2 who has performed the operation, on the basis of the acquired information, on the investor device output unit 570, and further displays the information received from the server 10 on the investor device output unit 570.

In the case where the content of the redelivery availability information for each music content indicates that the music content is allowed to be redelivered to other devices other than the investor device 50, the redelivery unit 529 redelivers the music content to other devices other than the investor device 50 in response to the operation of the investor U2.

The investor device recording unit 530 is composed of storage devices such as, for example, a ROM, a RAM, an HDD, and the like, and records the results of processing by the investor device control unit 510.

The investor device input unit 550 is, for example, a keyboard, a mouse, or a touch panel, and the investor device output unit 570 is, for example, a display, a loudspeaker, or a printer.

The profit manager device 70 is, for example, a computer, a tablet terminal, or a smart phone that includes a profit manager device control unit 710, a profit manager device recording unit 730, a profit manager device input unit 750, and a profit manager device output unit 770.

A profit manager U3 may be, for example, an accountant of the office to which each artist U1 belongs, a person in charge of the copyright management organization, or the artist U1 himself/herself. In the case where the artist U1 is the profit manager U3, the artist device 30 and the profit manager device 70 may be the same computer, tablet terminal, or smartphone.

The profit manager device control unit 710 is composed of an arithmetic processing unit such as a CPU, a memory, I/O devices, and the like. The profit manager device control unit 710 reads and executes a prescribed program to function as a profit information transmission unit 721 and as a fund use information transmission unit 725.

The profit information transmission unit 721 transmits profit information to the server 10 in response to the operation of the profit manager U3. The fund use information transmission unit 725 transmits the fund use information to the server 10 in response to the operation of the profit manager U3.

The profit manager device recording unit 730 is composed of storage devices such as, for example, a ROM, a RAM, an HDD, and the like, and records the results of processing by the profit manager device control unit 710.

The profit manager device input unit 750 is, for example, a keyboard, a mouse, or a touch panel, and the profit manager device output unit 770 is, for example, a display or a printer.

The communication network 90 is, for example, a local area network (LAN), a wide area network (WAN), or the Internet communication network.

<Processing Overview of Music Investment System>

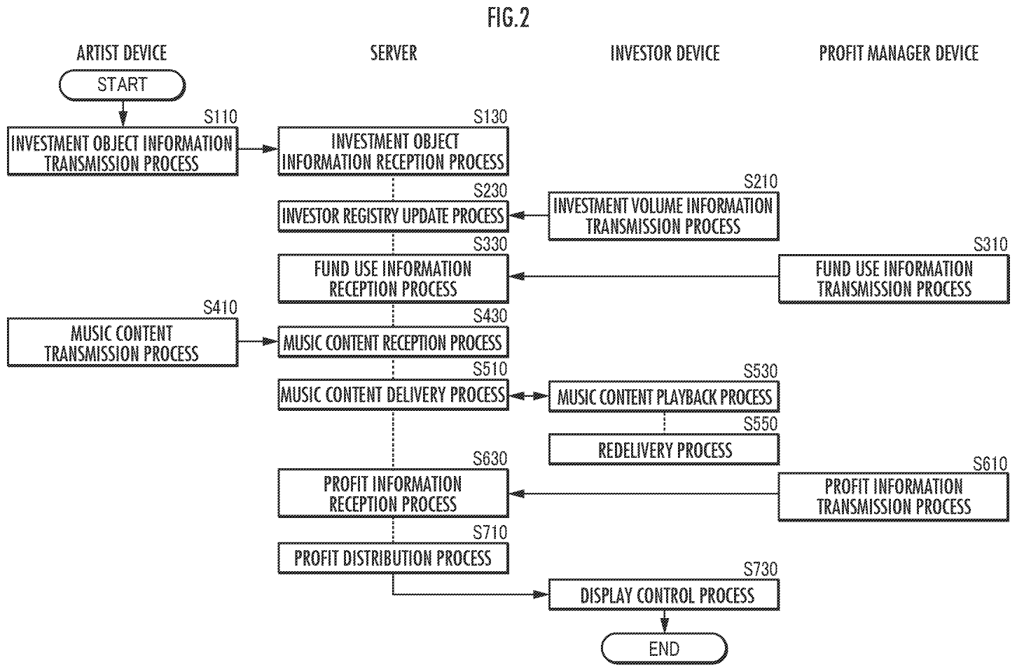

Referring to FIG. 2, an overview of the overall processing of the music investment system of this embodiment is described.

A series of processes by the music investment system of this embodiment is started with the investment object information transmission process (S110 in FIG. 2) by the artist device 30.

In the investment object information transmission process (S110 in FIG. 2), investment object information is transmitted from the artist device 30 to the server 10. Then, the server 10 performs an investment object information reception process (S130 in FIG. 2) of receiving the investment object information transmitted from the artist device 30 and recording the investment object information into the server recording unit 130.

Thereafter, the investor device 50 performs an investment volume information transmission process (S210 in FIG. 2) of transmitting the investment volume information to the server 10, and the server 10 performs an investor registry update process (S230 in FIG. 2) of preparing investor registry information and recording the investor registry information into the server recording unit 130 on the basis of the investment volume information received from the investor device 50.

Then, as needed, the profit manager device 70 performs a fund use information transmission process (S310 in FIG. 2) of transmitting fund use information to the server 10, and the server 10 performs a fund use information reception process (S330 in FIG. 2) of receiving the fund use information from the profit manager device 70 and recording the fund use information into the server recording unit 130.

Thereafter, the artist device 30 performs a music content transmission process (S410 in FIG. 2) of transmitting the music content produced or purchased with the funds invested by the investor U2 to the server 10. Then, the server 10 performs a music content reception process (S430 in FIG. 2) of recording the music content received from the artist device 30 into the server recording unit 130, preparing ownership transfer information that indicates that the ownership of the music content is transferred to each investor U2, on the basis of ownership information contained in the investment object information corresponding to the music content and the volume of investment of each investor contained in the investor registry information to which the music content corresponds, and recording the ownership transfer information into the server recording unit 130.

Thereafter, the server 10 performs a music content delivery process (S510 in FIG. 2) of delivering the music content in response to a request from the investor device 50 or the like, and the investor device 50 performs a music content playback process (S530 in FIG. 2) of playing the music content that has been delivered from the server 10 in response to the operation of the investor U2. In addition, as needed, the investor device 50 performs a redelivery process (S550 in FIG. 2) of redelivering the music content delivered from the server 10 to a device other than the investor device 50 in response to the operation of the investor U2.

Thereafter, the profit manager device 70 performs a profit information transmission process (S610 in FIG. 2) of transmitting profit information including information identifying the source of profit payment of the music content delivered by the music content delivery unit 117 and information indicating the amount of profit, and the server 10 performs a profit information reception process (S630 in FIG. 2) of receiving the profit information and recording the profit information into the server recording unit 130.

Thereafter, the profit manager device 70 performs a profit distribution process (S710 in FIG. 2) of deciding the quantity of profit distributed to each investor U2 for each investment object on the basis of the ownership transfer information and the profit information, issuing tokens according to the decided quantity of profit distributed to each investor U2 to each investor U2, and recording the information indicating the quantity of the issued tokens into the server recording unit 130.

Then, in response to the operation of the investor U2, the investor device 50 performs a display control process (S730 in FIG. 2) of acquiring the investor registry information, the ownership transfer information, the profit information, and the information indicating the quantity of tokens issued to the investor, and alternatively further the fund use information, all of which are recorded in the server recording unit 130, and displaying the respective information on the investor device 50, and the entire processing of the music investment system is completed.

For the sake of simplicity of description, it has not been described in FIG. 2 that, after the investor registry update process (S230 in FIG. 2) is performed and the investor registry information is prepared, the investor device 50 is allowed to acquire and display the investor registry information recorded in the server recording unit 130, as needed, in response to the operation of the investor U2. Similarly, after the process of recording the ownership transfer information, the profit information, and the fund use information, the investor device 50 is allowed to acquire and display the above information recorded in the server recording unit 130, as needed, in response to the operation of the investor U2.

The series of processes is repeated as needed in response to the operations of the artist U1, the investor U2, and the profit manager U3.

In the case of a plurality of servers 10, the servers 10 perform a blockchain process of generating block data on the basis of a certain number of pieces of prescribed information each time the certain number of pieces of prescribed information are recorded into the server recording unit 130, adding the block data to a blockchain, and managing the blockchain in a distributed manner with other servers 10.

The prescribed information is, for example, the investment object information, the investor registry information, the ownership transfer information, the profit information, the information indicating the quantity of tokens issued to the investor, and the fund use information.

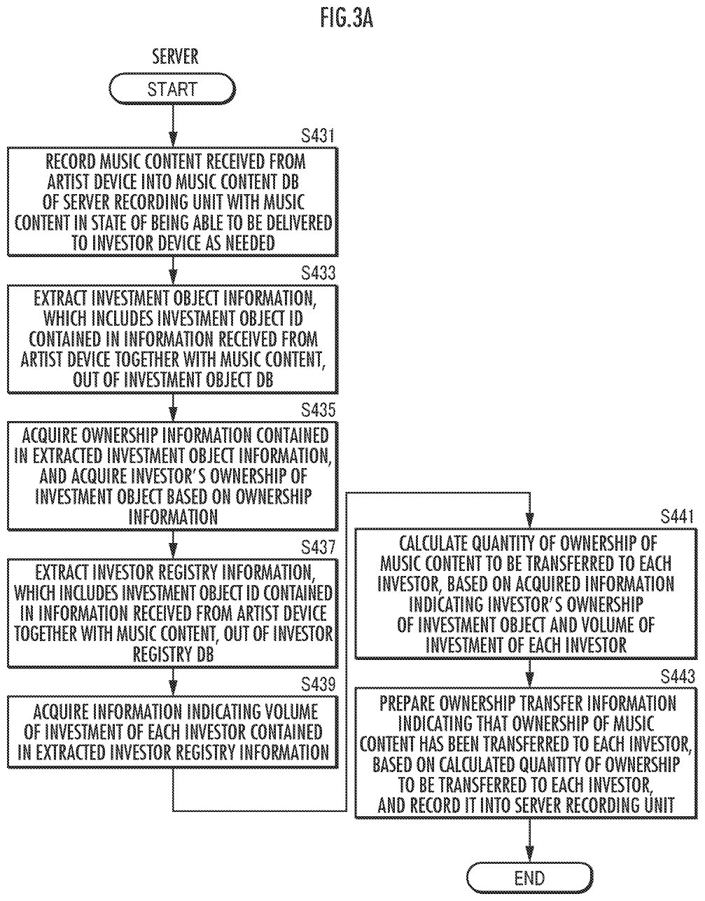

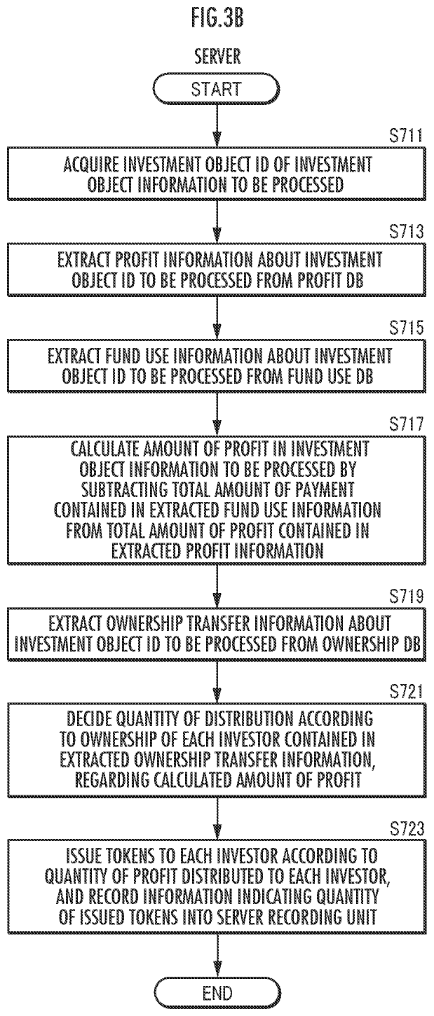

Subsequently, the contents of the respective processes are described with reference to FIGS. 3A to 5.

<Investment Object Information Transmission Process>

The investment object information transmission process is started, for example, by the artist U1 performing an operation of starting the investment object information transmission process on the artist device 30.

When the investment object information transmission process is started, the investment object information transmission unit 311 of the artist device 30 displays a screen for accepting an input of information about the investment object on the display as the artist device output unit 370.

The investment object information transmission unit 311 accepts the input of information about the investment object, such as, for example, an artist ID as information identifying the artist, the title of the music to be produced or purchased, an expected amount of profit, an investment offer period, a scheduled delivery date of the music, promotional videos, and ownership information indicating the ownership of the artist and the ownership of the investor of the investment object.

Then, when recognizing, for example, that the transmission button has been pressed by the artist U1, the investment object information transmission unit 311 transmits the information about the investment object information, whose input has been accepted, to the server 10 to complete the process.

<Investment Object Information Reception Process>

The investment object information reception process is started by the investment object information reception unit 111 of the server 10 receiving the investment object information from the artist device 30.

When the investment object information reception process is started, the investment object information reception unit 111 records the received investment object information with the investment object ID that identifies the investment object information into the investment object DB 131 of the server recording unit 130 to complete the process.

<Investment Volume Information Transmission Process>

The investment volume information transmission process is started, for example, by the investor U2 performing an operation of starting the investment volume information transmission process on the investor device 50.

When the investment volume information transmission process is started, the investment volume information transmission unit 513 of the investor device 50 connects to the server 10 to acquire the investment object information about the investment object, for which the investment is currently accepted, from the investment object DB 131 recorded in the server recording unit 130, and then displays the acquired investment object information in a list on the display, which is the investor device output unit 570.

When recognizing, for example, that the investor U2 has performed an operation of selecting one piece of investment object information from the list, the investment volume information transmission unit 513 displays a screen for accepting the input of information indicating the volume of investment for the selected investment object information, on the display.

The investment volume information transmission unit 513 accepts the input of information indicating the volume of investment such as, for example, the amount of cash or the quantity of tokens to be used for the current investment out of the tokens issued by the music investment system to the investor U2 in the past. In the case of accepting an input of the amount of cash as information indicating the volume of investment, the investment volume information transmission unit 513 also accepts the input of information necessary for the settlement of the cash, such as a credit card number, a bank account number, or the like.

When recognizing, for example, that the transmission button has been pressed by the investor U2, the investment object information transmission unit 311 transmits the investment volume information including the information indicating the volume of investment whose input has been accepted, the investment object ID, and the investor ID as information identifying the investor U2 to the server 10 to complete the process.

<Investor Registry Update Process>

The investor registry update process is started by the investor registry update unit 113 of the server 10 receiving the investment volume information from the investor device 50.

When the investor registry update process is started, the investor registry update unit 113 prepares investor registry information including an investment object ID, an investor ID, and information indicating the volume of investment on the basis of the investment volume information received from the investor device 50, and records the investor registry information into the investor registry DB 133 of the server recording unit 130 to complete the process.

The investor registry update unit 113 records the investor registry information and gives the investor U2, who has made the investment, the authority to display a screen (page) where the investor U2 is able to perform an operation of playing and redelivering the music content related to the investment object.

<Fund Use Information Transmission Process>

The fund use information transmission process is started, for example, by the profit manager U3 performing an operation of starting the fund use information transmission process on the profit manager device 70.

When the fund use information transmission process is started, the fund use information transmission unit 725 of the profit manager device 70 connects to the server 10 to acquire the investment object information from the investment object DB 131 recorded in the server recording unit 130, and then displays the acquired investment object information in a list on the display, which is the profit manager device output unit 770.

When recognizing, for example, that the balance manager U3 has performed an operation of selecting one piece of investment target information from the list, the fund use information transmission unit 725 displays a screen for accepting an input of the fund use information, which is information indicating the use of funds for the selected investment object information, on the display.

The fund use information transmission unit 725 accepts the input of fund use information such as, for example, a sentence describing the use of the funds (for example, “part of the original production cost,” “advertising and sales promotion cost,” or the like) and the amount of payment for each use of the funds.

Then, when recognizing, for example, that the balance manager U3 has pressed the transmission button, the fund use information transmission unit 725 transmits information including the fund use information whose input has been accepted, the investment object ID, and the balance manager ID as information that identifies the balance manager to the server 10 to complete the process.

<Fund Use Information Reception Process>

The fund use information reception process is started by the fund use information reception unit 123 of the server 10 receiving the fund use information from the profit manager device 70. When the fund use information reception process is started, the fund use information reception unit 123 records the received fund use information into the fund use DB 143 of the server recording unit 130 to complete the process.

This allows investors to invest with more confidence since the investors are able to see how their invested funds are being used as needed, thus increasing the possibility that the artist U1 is able to raise a lot of funds.

<Music Content Transmission Process>

The music content transmission process is started, for example, by the artist U1 performing an operation of starting the music content transmission process on the artist device 30.

When the music content transmission process is started, the music content transmission unit 317 of the artist device 30 acquires the investment object information of the artist from the investment object DB 131 recorded in the server recording unit 130, and then displays the acquired investment object information in a list on the display of the artist device 30.

When recognizing, for example, that the artist U1 has performed an operation of selecting one piece of investment object information from the list, the music content transmission unit 317 displays a screen for accepting the input of the music content for the selected investment object information, on the display.

The music content transmission unit 317 accepts the input of a music content such as audio data and image data with sound. The music content includes not only a finished music that has been produced with the investor's investment as funds or an entire purchased music, but also messages of thanks to the investors, a thank-you video, an online live video, and the like.

Alternatively, further the music content transmission unit 317 also accepts an input of delivery object information, which is information indicating the investor U2 to which the music content is to be delivered, or an input of redelivery availability information, which is information indicating whether the investor U2 is allowed to redeliver the music content to other devices.

When recognizing, for example, that the artist U1 has pressed the transmission button, the music content transmission unit 317 transmits information including the music content whose input has been accepted, the investment object ID, and, as needed, one or both of the delivery object information and the redelivery availability information, to the server 10 to complete the process.

<Music Content Reception Process>

The music content reception process is started by the server 10 receiving the music content from the artist device 30.

The music content reception unit 115 records the music content received from the artist device 30 into the music content DB 135 of the server recording unit 130 in a state that enables the music content to be delivered to the investor device 50 as needed. Further, the music content reception unit 115 prepares the ownership transfer information indicating that the ownership of the music content has been transferred to each investor U2, on the basis of the ownership information contained in the investment object information corresponding to the music content and the volume of investment of each investor U2 contained in the investor registry information to which the music content corresponds, and then records the ownership transfer information into the server recording unit 130 to complete the process.

More specifically, the music content reception unit 115 first records the music content received from the artist device 30 into the music content DB of the server recording unit 130, with the music content in a state of being able to be delivered to the investor device 50 as needed (S431 in FIG. 3A).

Then, the music content reception unit 115 extracts the investment object information, which includes the investment object ID contained in the information received together with the music content from the artist device 30, from the investment object DB 131 as investment object information corresponding to the music content (S433 in FIG. 3A).

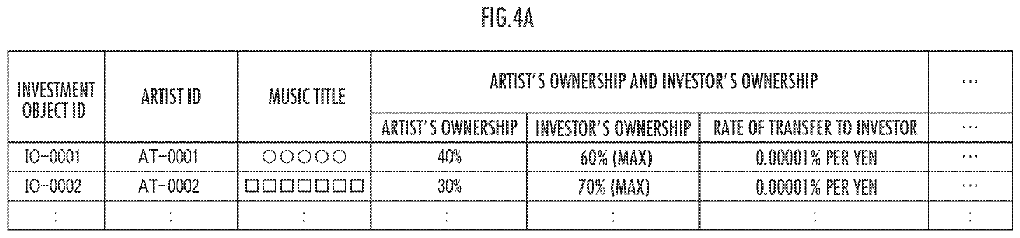

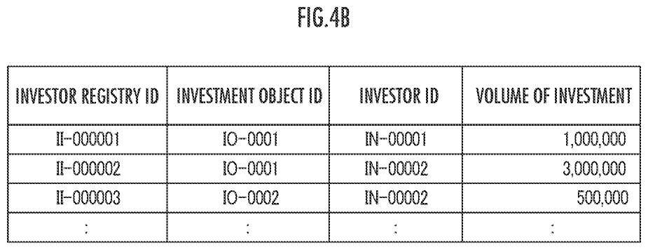

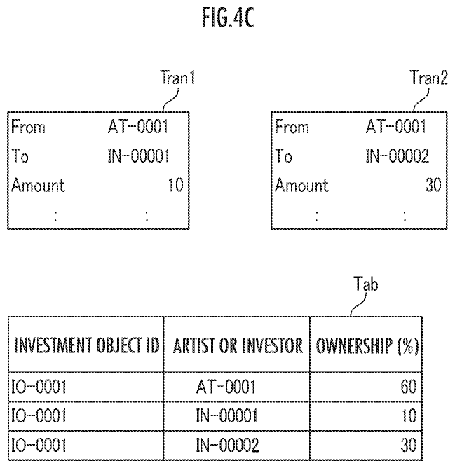

For example, in the case of an embodiment where “IO-0001” is the investment object ID contained in the information received with the music content from the artist device 30 and the content of the investment object information recorded in the investment object DB 131 is as illustrated in FIG. 4A, the music content reception unit 115 extracts the investment object information with the investment object ID “IO-0001,” as the investment object information corresponding to the music content, from the investment object DB 131.

Subsequently, the music content reception unit 115 acquires the ownership information contained in the extracted investment object information, and acquires the ownership of the investor U2 of the investment object on the basis of the ownership information (S435 in FIG. 3A).

In this embodiment, the ownership information contained in the extracted investment object information is as follows: “Ownership: artist 40%, investor 60% (maximum) For the investor, 0.00001% per yen is transferred.” Therefore, the music content reception unit 115 acquires information that “0.00001% per yen is transferred to the investor, and up to 60% is transferred to the investor” as the ownership of the investor U2 of the investment object.

Subsequently, the music content reception unit 115 extracts the investor registry information, which includes the investment object ID contained in the information received with the music content from the artist device 30, from the investor registry DB 133 (S437 in FIG. 3A).

In other words, for example, in the case of an embodiment where “IO-0001” is the investment object ID contained in the information received with the music content from the artist device 30 and the content of the investor registry information recorded in the investor registry DB 133 is as illustrated in FIG. 4B, the music content reception unit 115 extracts the investor registry information with the investment registry information ID of “II-000001” and “II-000002” as the investor registry information corresponding to the music content from the investment object DB 131 since the investor registry information whose investment object ID is “IO-0001” is the investor registry information with the investment registry information ID of “II-000001” and “II-000002.”

Then, the music content reception unit 115 acquires information indicating the volume of investment of each investor U2 contained in the extracted investor registry information (S439 in FIG. 3A).

In this embodiment, the music content reception unit 115 acquires “1,000,000 yen” as the volume of investment of the investor U2 whose investor ID is “IN-00001,” and acquires “3,000,000 yen” as the volume of investment of the investor U2 whose investor ID is “IN-00002.”

In the case where an investment is made with tokens, referring to the rate information between the amount of cash and the quantity of tokens (for example, 1 token=1 yen), which is recorded in the server recording unit 130 in advance, the quantity of tokens as the volume of investment of the investor U2 is converted into the amount of cash, and the value after the conversion is acquired as the volume of investment of the investor U2.

Subsequently, the music content reception unit 115 calculates the quantity of the ownership in the music content that should be transferred to each investor on the basis of the acquired information indicating the investor's ownership of the investment object and the volume of investment of each investor (S441 in FIG. 3A),

In this embodiment, the music content reception unit 115 calculates “10%” corresponding to “1 million yen” as the quantity of ownership to be transferred to the investor U2 whose investor ID is “IN-00001” and “30%” corresponding to “3 million yen” as the quantity of ownership to be transferred to the investor U2 whose investor ID is “IN-00002.”

Then, the music content reception unit 115 prepares ownership transfer information indicating that the ownership of the music content has been transferred to each investor U2 on the basis of the calculated quantity of ownership to be transferred to each investor U2, and records the ownership transfer information into the ownership DB 137 of the server recording unit 130 (S443 in FIG. 3A) to complete the process.

In this embodiment, the music content reception unit 115 prepares ownership transfer information whose content is, for example, as illustrated in FIG. 4C. In FIG. 4C, the data image Tran1 on the left in the upper part is the ownership transfer information to the investor U2 whose investor ID is “IN-00001,” and the data image Tran2 on the right in the upper part is the ownership transfer information to the investor U2 whose investor ID is “IN-00002.” The data image Tab in the lower part represents the content of the ownership DB reflecting these two pieces of ownership transfer information.

Although the preparation of the ownership transfer information during the music content reception process has been described in this embodiment, the preparation process is not limited thereto. Also when the investor registry update unit 113 receives the investment volume information from the investor device 50 and performs the investor registry update process after the music content reception process is performed, similarly the music content reception unit 115 prepares the ownership transfer information indicating that the ownership has been transferred to the investor U2 who has transmitted the investment volume information on the basis of the information indicating the volume of investment contained in the received investment volume information.

When receiving delivery object information together with the music content, the music content reception unit 115 records the music content on the basis of the delivery object information in a state that enables the music content to be delivered to the investor device 50 of the investor U2 to which the music content is to be delivered.

Furthermore, when receiving the redelivery availability information together with the music content, the music content reception unit 115 records the music content in a state where the music content is redeliverable (or not redeliverable) to other devices other than the investor device 50, on the basis of the redelivery availability information.

<Music Content Playback Process>

The music content playback process is started, for example, by the investor device 50 displaying a screen (page) on which a music content playback operation is able to be performed.

When the music content playback process is started, the music content playback unit 519 of the investor device 50 connects to the server 10 to acquire the investment object information about the music content recorded in a state that enables the music content to be delivered to the investor device 50 from the investment object DB and the music content DB 135 recorded in the server recording unit 130, and then displays the acquired investment object information in a list on the display of the investor device.

Then, when recognizing, for example, that the investor U2 has performed an operation of selecting one piece of investment object information from the list, the music content playback unit 519 transmits information that requests the delivery of the music content related to the selected investment object information to the server 10, accepts the delivery of the music content from the server 10, and starts the playback of the delivered music content.

In the case where there is a plurality of music contents related to one piece of investment object information, the music content playback unit 519 further accepts the information for selecting the music content to be played and plays the selected music content.

Thereafter, the music content playback unit 519 terminates the process when the music content is played to the end or when recognizing the operation of terminating the playback by the investor U2.

<Music Content Delivery Process>

The music content delivery process is started, for example, by receiving information for requesting delivery of a music content from the investor device 50.

When the music content delivery process is started, the music content delivery unit 117 acquires the music content, whose delivery has been requested by the investor device 50, from the music content DB of the server recording unit 130 and starts to deliver the acquired music content to the investor device 50 that requested the delivery of the music content.

At this time, the music content delivery unit 117 delivers the music content to the investor device 50 of the investor U2, in the case where the investor device 50 that requested the delivery of the music content is the investor device 50 of the investor U2 to which the music content is to be delivered, on the basis of the delivery object information, regarding the music content with which delivery object information is received in the music content reception process.

This enables an artist to deliver a music content as a limited content that is to be delivered to specific investors. The investors who received the limited content will feel more familiar with the artist and will be more willing to invest in the artist, thus increasing the possibility that the artist is able to raise a lot of funds.

Then, the music content delivery unit 117 terminates the process when the music content playback process is completed at the destination investor device 50.

In the case where the music content is recorded in the server recording unit 130 in a state where the music content is redeliverable to other devices other than the investor device 50, the music content delivery unit 117 starts the music content delivery process to other devices concerned when receiving information for requesting the delivery of the music content from other devices concerned.

<Redelivery Process>

The redelivery process is started by the redelivery unit 529 recognizing that a redelivery operation has been performed at the investor device 50 during the music content playback process, for example.

When the redelivery process is started, the redelivery unit 529 of the investor device 50 displays other devices allowed to be selected as redelivery destinations in a list.

The redelivery unit 529 acquires and displays a list of other devices that are allowed to be selected as redelivery destinations, for example, from the list information previously recorded in the investor device recording unit 530.

In the case where there is a plurality of redeliverable music contents related to one piece of investment object information, the redelivery unit 529 further accepts the information for selecting the redeliverable music content and redelivers the selected music content.

The redelivery unit 529 then transmits information such as the data itself of the music content to be redelivered or the URL to access the music content to, for example, an SNS, music delivery service, and the like accessible from the investor device 50 selected from the list of other devices that can be selected, on the basis of the operation of the investor U2, thereby redelivering the music content and completing the process.

This allows the investors themselves to participate in the promotional activities of the artist, which raises their expectations of earning a large amount of profit depending on their own efforts, thus increasing the investors' willingness to invest, which in turn increases the possibility that the artist is able to raise a lot of funds.

<Profit Information Transmission Process>

The profit information transmission process is started, for example, by the profit manager U3 performing an operation of starting the profit information transmission process on the profit manager device 70.

When the profit information transmission process is started, the profit information transmission unit 721 of the profit manager device 70 connects to the server 10 to acquire the investment object information from the investment object DB 131 recorded in the server recording unit 130, and displays the acquired investment object information in a list on the display of the profit manager device 70.

When recognizing, for example, that the balance manager U3 has performed an operation of selecting one piece of investment object information from the list, the profit information transmission unit 721 displays a screen for accepting the input of profit information about the music content related to the selected investment object information, on the display.

The profit information transmission unit 721 accepts the inputs of profit information such as, for example, information identifying the source of profit payment (for example, a corporate name and its location, a payment source ID, or the like), information indicating the amount of profit, and text describing the content of the activity that is the source of the profit (for example, “music content delivery sales,” “music listening site ◯◯ usage fees,” or the like).

When recognizing, for example, that the balance manager U3 has pressed the transmission button, the profit information transmission unit 721 transmits information including the profit information and the investment object ID, whose respective inputs have been accepted, to the server 10 to complete the process.

<Profit Information Reception Process>

The profit information reception process is started by the profit information reception unit 119 of the server 10 receiving the profit information and the investment object ID from the profit manager device 70. Upon the start of the profit information reception process, the profit information reception unit 119 records the received investment object ID and the profit information into the profit DB 139 of the server recording unit 130 to complete the process.

<Profit Distribution Process>

The profit distribution process is started on the server 10, for example, at a prescribed timing (once, monthly, or the like) or at any time in response to the operation of the profit manager U3.

When the profit distribution process is started, the profit distribution unit 121 decides the amount of profit distributed to each investor U2 for each investment object on the basis of the ownership transfer information and the profit information. Further, the profit distribution unit 121 issues tokens to each investor U2 according to the decided amount of profit distributed to each investor U2 and records information indicating the quantity of the issued tokens into the token DB 141 of the server recording unit 130 to complete the process.

More specifically, the profit distribution unit 121 first acquires the investment object ID of the investment object information to be processed (S711 in FIG. 3B).

Subsequently, the profit distribution unit 121 extracts the profit information about the investment object ID to be processed from the profit DB (S713 in FIG. 3B) and extracts the fund use information about the investment object ID to be processed from the fund use DB (S715 in FIG. 3B). Then, the profit distribution unit 121 calculates the amount of profit in the investment object information to be processed by subtracting the total amount of payment contained in the extracted fund use information from the total amount of profit contained in the extracted profit information (S717 in FIG. 3B).

For example, in the case where the amount of profit from which necessary expenses are deducted in advance is received and recorded in the profit DB 139 in the profit information reception process, the process in S715 is omitted, and the profit distribution unit 121 calculates the total value of the amount of profit included in the extracted profit information as the amount of profit of the investment object information to be processed in S717.

Then, the profit distribution unit 121 extracts the ownership transfer information about the investment object ID to be processed from the ownership DB (S719 in FIG. 3B).

Regarding the amount of profit calculated in S717, the profit distribution unit 121 decides the quantity of distributed profit according to the ownership of each investor U2 contained in the extracted ownership transfer information (S721 in FIG. 3B), issues tokens to each investor U2 according to the quantity of profit distributed to each investor U2, and records information indicating the quantity of the issued tokens into the server recording unit (S723 in FIG. 3B) to complete the process.

Specifically, for example, when the calculated profit amount is 1,000,000 yen and one investor U2 has a 10% ownership and another investor U2 has a 30% ownership, the profit distribution unit 121 decides that the quantity of profit distributed to one investor U2 is 100,000 yen and the quantity of profit distributed to another investor U2 is 300,000 yen. Then, for example, when the rate between the amount of profit distribution and the quantity of tokens is “1 yen=1 token,” the profit distribution unit 121 issues 100,000 tokens for one investor U2 and 300,000 tokens for another investor U2.

Alternatively, the profit distribution unit 121 may be configured to decide the quantity of the distributed profit calculated in S717 according to the artist's ownership in the extracted ownership transfer information and to issue tokens or pay cash according to the quantity of the distributed profit.

<Display Control Process>

The display control process is started by the investor U2 performing an operation of starting the display control process in the investor device 50.

When the display control process is started, the investor device display control unit 523 displays a screen for accepting the specification of information that the investor U2 wishes to display, on the display of the investor device 50. The investor device display control unit 523 accepts the specification of information that the investor U2 wishes to display, such as, for example, investor registry information, ownership transfer information, profit information, information indicating the quantity of tokens issued to the inventor, and information indicating the volume of investment.

When recognizing that the operation of specifying the information that the investor U2 wishes to display has been performed, the investor device display control unit 523 refers to the DB corresponding to the specified information among the DBs recorded in the server recording unit 130 to acquire the information that the investor U2 wishes to display.

Then, the investor device display control unit 523 aggregates, edits, and lists the acquired information on the display of the investor device 50 as necessary to complete the process.

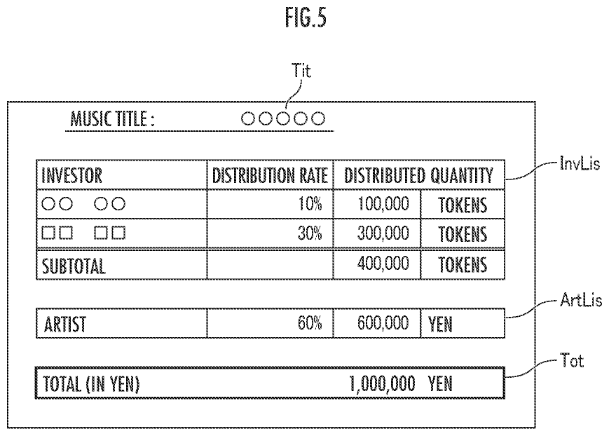

For example, when information indicating the quantity of tokens issued to the investor is specified as the information wished to be displayed, the investor device display control unit 523 refers to the token DB 141 to acquire the information indicating the quantity of tokens issued to the investor U2, and lists the information on the display of the investor device 50 as illustrated in FIG. 5. In FIG. 5, the investor device display control unit 523 acquires the title of the music from the investment object DB 131 and displays the music title Tit, and then acquires the name of the investor U2, which is recorded in advance in the server recording unit 130, calculates the subtotal of the distribution rate to each investor U2 and the quantity distributed to the investor U2 on the basis of the information indicating the quantity of tokens acquired from the token DB 141, and displays a table InvLis illustrating the content of the distribution to the investor. The investor device display control unit 523 further acquires the ownership of the artist U1 from the ownership DB 137 and displays the ownership as a table ArtLis together with the amount distributed to the artist U1, calculates and displays a sum Tot of the subtotal of the quantity distributed to the investor U2 converted into yen and the amount distributed to the artist U1, so that each investor U2 is able to view the distribution rate and the total quantity distributed to each investor U2, including the investor U2 himself/herself. Similarly, for example, in the case where information indicating the volume of investment is specified as information wished to be displayed, the investor device display control unit 523 displays the content including the information indicating the volume of investment related to each investor U2. Alternatively, for example, in the case where ownership transfer information is specified as information wished to be displayed, the investor device display control unit 523 displays the content including information indicating the quantity of ownership transferred to each investor U2.

This allows the investor U2 to invest with confidence because the investor U2 is able to confirm at any time that the ownership commensurate with his/her investment has been transferred to each investor U2 and that each investor U2 has received the distribution corresponding to his/her ownership, thus increasing the possibility that the artist U1 is able to raise a lot of funds.

<Blockchain Process>

The blockchain process is started each time a certain number of pieces of prescribed information are recorded into the server recording unit 130.

When the blockchain process is started, the blockchain unit 125 generates block data using a certain number of pieces of recorded prescribed information and the hash value of the most recently prepared block data, adds the block data to the blockchain, and transmits the block data to other servers 10 for distributed management of the blockchain with other servers 10 to complete the process.

This increases the certainty that important information, such as investor registry information, profit information, and information indicating the quantity of profit distributed to each investor, has not been falsified, by which the investor is able to make an investment with more confidence, thus increasing the possibility that the artist is able to raise a lot of funds.

As described above, according to the music investment system of the present invention, it is possible to provide a music investment system that enables investors U2 to invest with confidence since the transparency of the flow of invested funds is maintained in the music investment system.

Although the embodiments of the present invention have been described hereinabove, the present invention is not limited thereto. Various modifications are possible without departing from the gist of the present invention.

For example, in response to the operation of the artist U1, the artist device 30 may be configured to acquire and display the investor registry information, the ownership transfer information, the profit information, the information indicating the quantity of tokens issued to the investor U2, and the fund use information, each of which is recorded in the server recording unit 130, on the display of the artist device 30.

Although this embodiment has been described, for example, assuming a case where the server 10, the artist device 30, the investor device 50, and the profit manager device are present separately, the present invention is not limited thereto. Specifically, for example, the artist device 30 and the server 10 or the investor device 50 and the server 10 may be the same device. In this case, the same device functions as the artist device 30 and the server 10 (or as the investor device 50 and the server 10).

Although this embodiment has been described, for example, assuming a case where the server 10 receives and records the profit information in response to the operation of the profit manager U3, the present invention is not limited thereto. The server 10 may be configured to charge at the timing when the music content delivery unit 117 delivers a music content in the music content delivery process, to prepare profit information on the basis of the charged amount, and to record the profit information into the profit DB 139 of the server recording unit 130.

### DESCRIPTION OF REFERENCE NUMERALS

10 server
30 artist device
50 investor device
70 profit manager device
90 communication network
111 investment object information reception unit
113 investor registry update unit
115 music content reception unit
117 music content delivery unit
119 profit information reception unit
121 profit distribution unit
123 fund use information reception unit
125 blockchain unit
130 server recording unit
523 investor device display control unit
529 redelivery unit

1. A music investment system, having a computer network including a server, an artist device, and an investor device,
wherein the server includes:
an investment object information reception unit that receives investment object information from the artist device and that records the investment object information in a recording unit, the investment object information being information about a music to be an object of investment by an investor and information including ownership information indicating ownership of an artist and ownership of the investor of the investment object;
an investor registry update unit that receives investment volume information including information identifying the investment object, information identifying the investor, and information indicating volume of investment from the investor device, prepares investor registry information based on the received investment volume information, and records the investor registry information in the recording unit;
a music content reception unit that receives music content, which is information including audio information of a music produced or purchased with funds invested by the investor from the artist device, records the music content in the recording unit, prepares ownership transfer information indicating that ownership of the music content has been transferred to each of the investor, based on the ownership information included in the investment object information corresponding to the music content and the volume of investment of the each of the investor included in the investor registry information to which the music content corresponds, and records the ownership transfer information in the recording unit;
a music content delivery unit that delivers the music content received by the music content reception unit to the investor device;
a profit information reception unit that receives profit information and records the profit information in the recording unit, the profit information including information identifying a source of profit payment of the music content delivered by the music content delivery unit and information indicating amount of profit; and
a profit distribution unit that decides quantity of profit to be distributed to the each investor for each investment object, based on the ownership transfer information and the profit information, issues tokens to the each investor according to the decided quantity of profit to be distributed to the each investor, and records information indicating quantity of the issued tokens in the recording unit,
wherein the investor device includes a display control unit that acquires each of the investor registry information, the ownership transfer information, the profit information, and the information indicating the quantity of the tokens issued to the investor recorded in the recording unit in response to an operation of the investor, and displays on the investor device based on the acquired information, the information identifying the investor, the information indicating the volume of investment, the information indicating the quantity of transferred ownership, or the information indicating the quantity of the issued tokens, each of which is related to the each investor including the investor himself/herself who performed the operation.

2. The music investment system according to claim 1,
wherein the music content reception unit is configured to receive also delivery object information, which is information indicating the investor who is to receive delivery of the music content, when receiving the music content from the artist device and
wherein the music content delivery unit is configured to deliver the music content to an investor device used by the investor who is to receive delivery, based on the delivery object information for the each music content, when delivering the music content to the investor device.

3. The music investment system according to claim 1,
wherein the music content reception unit is configured to receive also redelivery availability information, which is information indicating whether the investor is allowed to redeliver the music content to other devices, when receiving the music content from the artist device and
wherein the investor device includes a redelivery unit that redelivers the music content to other devices in response to an operation of the investor in a case where a content of the redelivery availability information for the each music content indicates that the music content is allowed to be redelivered to other devices.

4. The music investment system according to claim 1, further comprising a profit manager device,
wherein the server includes a fund use information reception unit that receives fund use information, which is information about the use of the funds invested by the investor, from the profit manager device and that records the fund use information in the recording unit, and
wherein the display control unit of the investor device acquires the fund use information recorded in the recording unit, and displays the fund use information on the investor device.

5. The music investment system according to claim 1,
wherein:
there are a plurality of servers as the server; and
each of the servers has a blockchain unit that generates block data based on prescribed information each time a certain number of pieces of the prescribed information are recorded in the recording unit, adds the block data to the blockchain, and performs distributed management of the blockchain with the other servers.
